(19) United States
(12) Patent Application Publication
(10) Pub. No.: US 2014/0216645 A1
(43) Pub. Date: Aug. 7, 2014

(54) Method for Forming Glass Layer and Method for Manufacturing Sealed Structure

(71) Applicant: Semiconductor Energy Laboratory Co., Ltd., Kanagawa-ken (JP)

(72) Inventor: Daiki Nakamura, Atsugi (JP)

(73) Assignee: Semiconductor Energy Laboratory Co., Ltd., Kanagawa-ken (JP)

(21) Appl. No.: 14/167,286

(22) Filed: Jan. 29, 2014

(30) Foreign Application Priority Data
Feb. 4, 2013 (JP) 2013-019095

(51) Int. Cl. B32B 37/14; B32B 37/06

(52) U.S. Cl. CPC B32B 37/14; B32B 37/06
USPC 156/272.8; 427/554

(57) ABSTRACT

To form a glass layer with high productivity over a substrate provided with a material whose upper temperature limit is low. A method for forming the glass layer includes a first step of providing a frit paste including a glass frit and a binder over a substrate, and a second step of relatively moving a laser light irradiation portion over the frit paste not to overlap with a laser light irradiation start portion. A track of the laser light irradiation portion in the second step has an intersection in an intersection portion.

### BACKGROUND OF THE INVENTION

1. Field of the Invention

One embodiment of the present invention relates to a glass layer, a sealed structure, a semiconductor device, a light-emitting device, or a display device, or relates to methods for forming these. In particular, one embodiment of the present invention relates to a method for forming a glass layer. Another embodiment of the present invention relates to a sealed structure using a pair of substrates and a glass layer and a method for forming the sealed structure. Another embodiment of the present invention relates to a semiconductor device, light-emitting device, display device, electronic device, or lighting device including the sealed structure.

2. Description of the Related Art

In recent years, development of light-emitting devices and display devices has been actively promoted, and high reliability, high yield, high productivity, and the like have been demanded.

Among objects to be sealed, an element whose performance (e.g., reliability) is rapidly degraded by being exposed to an atmosphere containing moisture or oxygen, such as a light-emitting element (also referred to as organic EL element) that utilizes an organic electroluminescence (hereinafter, also referred to as EL) phenomenon, is preferably provided inside a sealed structure having high hermeticity.

For example, a technique for forming a sealed structure having high hermeticity in which a pair of substrates is bonded to each other with a low-melting-point glass has been known.

Patent Document 1 discloses a glass package in which a pair of substrates is bonded to each other with a glass frit. Patent Document 1 also discloses a manufacturing method in which a glass frit is provided on one of a pair of substrates and is pre-sintered, the pair of substrates is made face each other, and the frit is heated to be melted, thereby bonding the pair of substrates.

In a process of pre-sintering the substrate on which the glass frit is provided, a paste (also referred to as fit paste) including, for example, a glass fit, an organic solvent, and a binder (e.g., a resin) is put on a substrate, and is heated to remove the organic solvent, the resin, and the like, whereby a glass layer is formed over the substrate.

At this time, if the frit paste is not sufficiently heated, the binder remains in the glass layer; as a result, there is a possibility that the sealed structure does not have sufficient hermeticity or a crack is readily formed in the glass layer.

The temperature needed for removing the binder from the frit paste (e.g., 350° C. to 450° C.) is higher than the upper temperature limit of an object to be sealed that is provided over the substrate in some cases. For example, in the case where a frit paste is provided over a substrate provided with an object to be sealed whose upper temperature limit is low, such as an organic EL element or a color filter, if the whole substrate is heated with a heating furnace or the like to remove the binder from the frit paste, the heat treatment probably degrades the object whose upper temperature limit is low.

In view of this, Patent Document 2 proposes a technique for forming a glass layer over a substrate by laser light irradiation. The laser light irradiation is locally performed to heat a frit paste; consequently, a binder can be removed from the fit paste and an object to be sealed can be prevented from being thermally damaged.

### REFERENCE

### Patent Document

[Patent Document 1] United States Published Patent Application No. 2004-0207314
[Patent Document 2] United States Published Patent Application No. 2012-0240628

### SUMMARY OF THE INVENTION

As described in Patent Document 2, when laser light irradiation is performed using a predetermined position P in a frit paste as start and end points of the laser light irradiation, a glass layer is severed in the vicinity of the predetermined position P in some cases. This seems to be because it is difficult for a melt termination end part of the frit paste (the glass layer) which shrinks due to melting of the glass frit to connect with a melt starting end part of the frit paste (the glass layer) which has already solidified.

Each of the melt starting end part and the melt termination end part in the glass layer is thicker than the other regions in the glass layer. Thus, when one of a pair of substrates is superposed on the other substrate with the glass layer positioned therebetween, the glass layer cannot come into uniform contact with the substrates. When fusing the glass layer by laser light irradiation in this state to bond the pair of substrates to each other with the glass layer, it is difficult to obtain a sealed structure having high hermeticity.

In view of the above, one object of one embodiment of the present invention is to form a glass layer and the like with high productivity. Another object of one embodiment of the present invention is to form a glass layer over a substrate provided with a material whose upper temperature limit is low. Another object of one embodiment of the present invention is to form a glass layer and the like capable of manufacturing a sealed structure having high hermeticity. Specifically, an object of one embodiment of the present invention is to form, with high productivity, a glass layer and the like capable of manufacturing a sealed structure having high hermeticity over a substrate provided with a material whose upper temperature limit is low.

Another object of one embodiment of the present invention is to manufacture a sealed structure having high hermeticity, with high productivity. Another object of one embodiment of the present invention is to provide a sealed structure having high hermeticity. Another object of one embodiment of the present invention is to provide a novel light-emitting device. Another object of one embodiment of the present invention is to provide a novel display device. Another object of one embodiment of the present invention is to provide a highly reliable sealed structure, light-emitting device, display device, electronic device, or lighting device.

Note that the description of these objects does not disturb the existence of other objects. In one embodiment of the present invention, there is no need to achieve all the objects. Other objects will be apparent from and can be derived from the description of the specification, the drawings, the claims, and the like.

One embodiment of the present invention is designed focusing on a track of a portion irradiated with laser light with which a frit paste is irradiated. In one embodiment of the present invention, a portion irradiated with laser light (also referred to as laser light irradiation portion) is relatively moved over the fit paste not to overlap with an irradiation start portion of the laser light (also referred to as laser light irradiation start portion). The track of the laser light irradiation portion has an intersection. An intersection portion including the intersection does not overlap with the laser light irradiation start portion.

In the case where the intersection portion of the track of the laser light irradiation portion does not overlap with the laser light irradiation start portion, the area of a glass layer disconnected portion can be small as compared to the case where the intersection portion overlaps with the laser light irradiation start portion. A difference in thickness between an edge of the glass layer and the other region of the glass layer can be small. Note that the expression “edge of a glass layer” in this specification means a portion in the glass layer located near the glass layer disconnected portion.

Specifically, one embodiment of the present invention is a method for forming a glass layer. The method includes a first step of providing a frit paste including a glass frit and a binder over a substrate; and a second step of relatively moving a laser light irradiation portion over the frit paste not to overlap with a laser light irradiation start portion. A track of the laser light irradiation portion in the second step has an intersection in an intersection portion.

Another embodiment of the present invention is a method for manufacturing a sealed structure. The method includes a first step of providing a frit paste including a glass frit and a binder over a first substrate; a second step of forming a glass layer in such a manner that a first laser light irradiation portion is relatively moved over the frit paste not to overlap with a first laser light irradiation start portion; and a third step of bonding the first substrate and a second substrate in such a manner that the first substrate and the second substrate are provided to face each other with the glass layer positioned therebetween, and the glass layer is irradiated with a second laser light to be melt. A track of the first laser light irradiation portion in the second step has an intersection in an intersection portion.

Another embodiment of the present invention is a method for forming a glass layer. The method includes a first step of providing a frit paste including a glass frit and a binder over a substrate; and a second step of relatively moving a laser light irradiation portion over the frit paste not to overlap with a laser light irradiation start portion. A track of the laser light irradiation portion in the second step has an intersection in an intersection portion, and forms an angle in the intersection portion.

Another embodiment of the present invention is a method for manufacturing a sealed structure. The method includes a first step of providing a frit paste including a glass frit and a binder over a first substrate; a second step of forming a glass layer in such a manner that a first laser light irradiation portion is relatively moved over the frit paste not to overlap with a first laser light irradiation start portion; and a third step of bonding the first substrate and a second substrate in such a manner that the first substrate and the second substrate are provided to face each other with the glass layer positioned therebetween, and the glass layer is irradiated with a second laser light to be melt. A track of the first laser light irradiation portion in the second step has an intersection in an intersection portion, and forms an angle in the intersection portion.

In any of the above embodiments of the present invention, the angle is preferably greater than 0° and less than or equal to 90°, more preferably greater than or equal to 10° and less than or equal to 80°, even more preferably greater than or equal to 20° and less than or equal to 70°, still more preferably greater than or equal to 30° and less than or equal to 60°, and particularly preferably greater than or equal to 40° and less than or equal to 50°.

In any of the above embodiments of the present invention, the angle is preferably greater than 0° and less than 80°, more preferably greater than 0° and less than or equal to 60°, even more preferably greater than 0° and less than or equal to 40°, and particularly preferably greater than 0° and less than or equal to 20°.

In any of the above embodiments of the present invention, the angle is preferably greater than or equal to 30° and less than or equal to 90°, more preferably greater than or equal to 50° and less than or equal to 90°, even more preferably greater than or equal to 70° and less than or equal to 90°, and particularly preferably greater than or equal to 80° and less than or equal to 90°.

In any of the above embodiments of the present invention, in the first step, the fit paste is preferably provided to form a frame-like shape.

In the method for manufacturing a sealed structure of one embodiment of the present invention, in the third step, the intersection portion of the track of the first laser light irradiation portion is irradiated with the second laser light more than once.

In one embodiment of the present invention, even when a disconnected portion exists in the glass layer, the area of the disconnected portion is small because the track of the laser light irradiation portion has an intersection in the intersection portion which does not overlap with the laser light irradiation start portion. In addition, a difference in thickness between an edge of the glass layer and the other region of the glass layer is small. Accordingly, when a pair of substrates is provided with the glass layer positioned therebetween and is bonded by melting the glass layer, the disconnected portion in the glass layer can be filled with the melted glass layer, whereby a sealed structure having high hermeticity can be manufactured.

In one embodiment of the present invention, a frit paste is locally heated by laser light irradiation to form a glass layer, in which case the glass layer can be formed over a substrate provided with a material having low heat resistance. In one embodiment of the present invention, a novel light-emitting device, display device, or the like can be provided. Note that the description of these effects does not disturb the existence of other effects. One embodiment of the present invention does not necessarily achieve all the objects listed above. Other effects will be apparent from and can be derived from the description of the specification, the drawings, the claims, and the like.

### BRIEF DESCRIPTION OF THE DRAWINGS

FIGS. 1A to 1D illustrate a method for forming a glass layer of one embodiment of the present invention.

FIGS. 2A to 2C illustrate a method for forming a glass layer (a comparative example).

FIGS. 3A to 3D illustrate a method for forming a glass layer of one embodiment of the present invention.

FIGS. 4A to 4C illustrate a method for manufacturing a sealed structure of one embodiment of the present invention.

FIGS. 5A to 5C illustrate a light-emitting device of one embodiment of the present invention.

FIGS. 6A and 6B illustrate a display device of one embodiment of the present invention.

FIGS. 7A to 7E illustrate electronic devices of one embodiment of the present invention.

FIG. 8 illustrates lighting devices of one embodiment of the present invention.

FIGS. 9A and 9B are optical photomicrographs of a glass layer of Example 1.

FIGS. 10A and 10B are optical photomicrographs of a glass layer of Example 1.

FIG. 11 is a graph showing the area of a portion where a glass layer of Example 1 is not formed.

FIGS. 12A to 12C are digital micrographs of a glass layer of Example 1.

FIGS. 13A and 13B are optical photomicrographs of a glass layer.

FIGS. 14A and 14B are optical photomicrographs of a glass layer.

### DETAILED DESCRIPTION OF THE INVENTION

Embodiments of the present invention are described in detail using the drawings The present invention is not limited to the following description, and it will be easily understood by those skilled in the art that various changes and modifications can be made without departing from the spirit and scope of the present invention. Therefore, the present invention should not be construed as being limited to the description in the following embodiments.

Note that in the structures of the invention described below, the same portions or portions having similar functions are denoted by the same reference numerals in different drawings, and description of such portions is not repeated. Further, the same hatching pattern is applied to portions having similar functions, and the portions are not especially denoted by reference numerals in some cases.

In addition, the position, size, range, or the like of each structure illustrated in drawings and the like is not accurately represented in some cases for easy understanding. Therefore, the disclosed invention is not necessarily limited to the position, size, range, or the like disclosed in the drawings and the like.

### Embodiment 1

In this embodiment, a method for forming a glass layer of one embodiment of the present invention and a method for manufacturing a sealed body of one embodiment of the present invention will be described with reference to drawings.

### <Method for Forming Comparative Glass Layer>

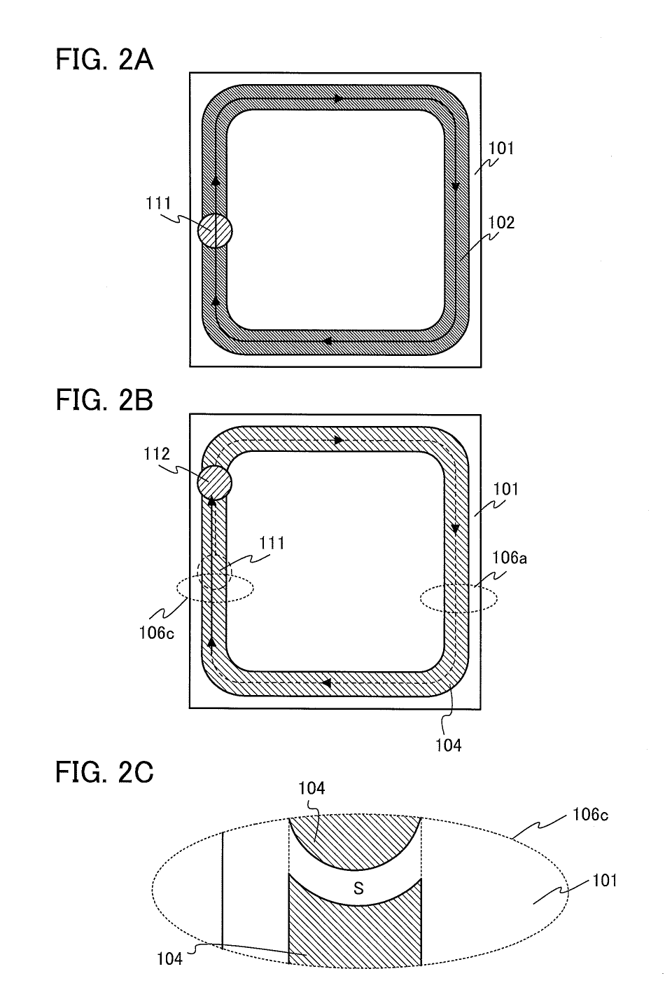

First, a method for forming a glass layer (a comparative example) will be described with reference to FIGS. 2A to 2C.

First, a frit paste 102 including a glass frit, an organic solvent, and a binder (e.g., a resin) is provided over a substrate 101 (FIG. 2A). Then, the frit paste 102 is irradiated with laser light, thereby forming a glass layer 104 from which the organic solvent, and the binder are removed (FIG. 2B).

A laser light irradiation start portion 111 is shown in FIG. 2A. In the comparative example, laser light irradiation is started on the frit paste 102. In the irradiation start portion 111, for example, a laser is turned on in a state where an object that blocks laser light, such as a shutter, is not provided between the laser and the frit paste 102, and the frit paste 102 is irradiated with the laser light. Alternatively, the laser is turned on in a state where an object that blocks laser light, such as a shutter, is provided between the laser and the frit paste 102, and then the object that blocks the laser light is removed and the frit paste 102 is irradiated with the laser light.

In this embodiment, laser light irradiation is performed along the frit paste 102 as shown by a track of solid line arrows in FIG. 2A (corresponding to a track of dotted line arrows in FIG. 2B). Then, laser light irradiation is performed to overlap with the irradiation start portion 111 as shown by a track of a solid line arrow in FIG. 2B, and the laser light irradiation is finished. A laser light irradiation terminating portion 112 is shown in FIG. 2B.

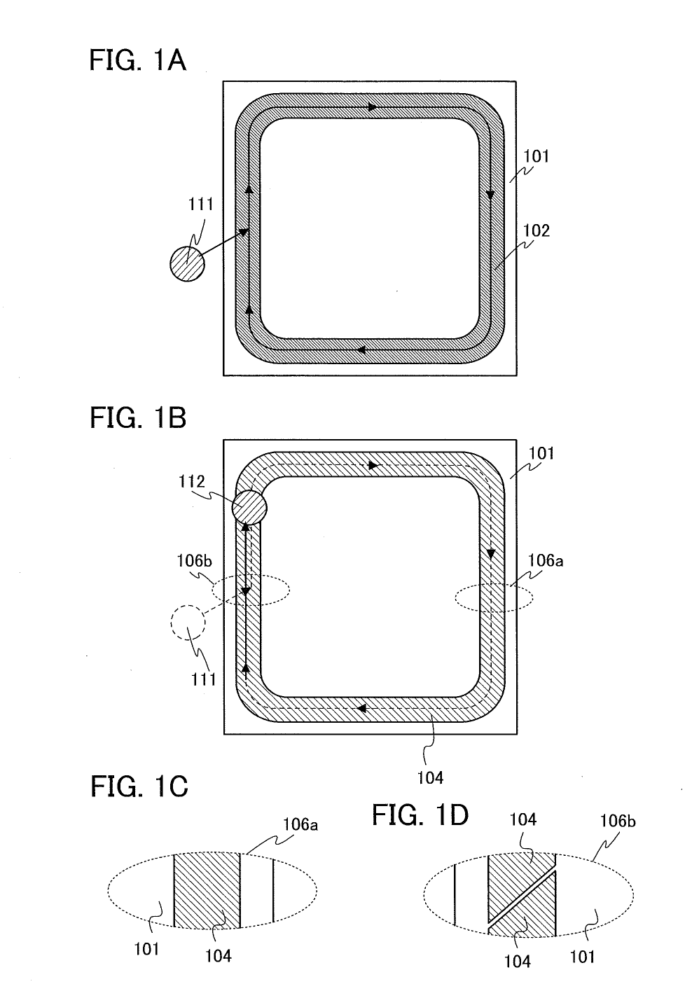

FIG. 1C is an enlarged view of a region 106a in FIG. 2B. FIG. 2C is an enlarged view of a region 106c in FIG. 2B. The region 106c includes a region of the irradiation start portion 111 which is irradiated with the laser light again.

In the region 106a, the continuous glass layer 104 is formed along a region where the frit paste 102 is provided as in FIG. 1C.

On the other hand, in the region 106c, a portion where the glass layer 104 is not formed (also referred to as glass layer disconnected portion or glass layer non-forming portion) exists in the region of the frit paste 102, and the glass layer 104 is not continuous as shown in FIG. 2C. When a pair of substrates is bonded using the glass layer 104 to form the sealed structure, as an area S of the glass layer non-forming portion is larger, the possibility of poor hermeticity of the sealed structure is increased.

Glass frits aggregate at an edge of the glass layer 104, and the thicknesses of some portions of the glass layer 104 are larger than those of the other portions of the glass layer 104. When a pair of substrates is superposed with the glass layer 104 positioned therebetween and the thickness of the glass layer 104 is uneven, the glass layer 104 cannot come into uniform contact with the pair of substrates. Even when the pair of substrates is bonded using the glass layer 104 melted by laser light irradiation in such a state, it is difficult to obtain a sealed structure having high hermeticity. In addition, thicker portions of the glass layer 104 are not preferable because it takes a long time to melt the portions and thus the scanning rate of the laser is decreased.

### <Method for Forming Glass Layer of One Embodiment of the Present Invention>

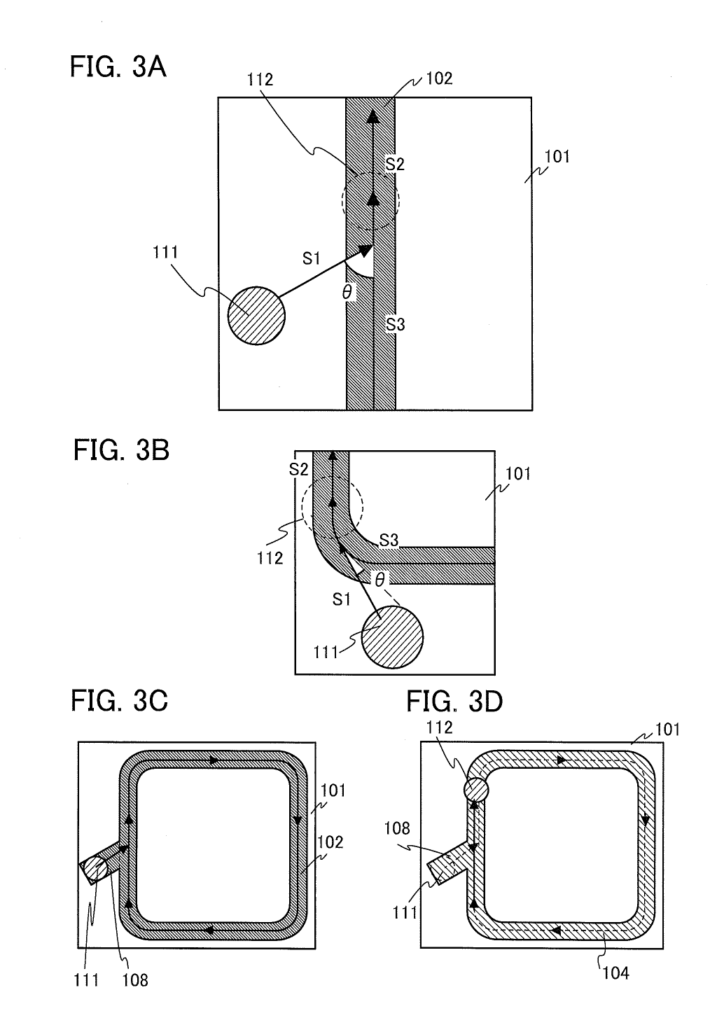

Next, a method for forming a glass layer of one embodiment of the present invention will be described with reference to FIGS. 1A to 1D and FIGS. 3A to 3D.

First, the frit paste 102 including a glass fit, an organic solvent, and a binder is provided over the substrate 101 (FIG. 1A).

The frit paste 102 is provided over the substrate 101 by a printing method such as screen printing or gravure printing, a coating method such as a dispensing method or an ink-jet method, or the like.

The fit paste includes a glass fit (a powdery glass material), an organic solvent, and a binder (e.g., a resin). The frit paste can be formed using a variety of materials and can employ a variety of structures. For example, terpineol, n-butyl carbitol acetate, or the like can be used as the organic solvent and a cellulosic resin such as ethylcellulose can be used as the resin. Furthermore, the frit paste may include a light-absorbing material that absorbs light having a wavelength of laser light.

A glass material used for the glass frit preferably contains one or more compounds selected from, for example, the following groups: magnesium oxide, calcium oxide, strontium oxide, barium oxide, cesium oxide, sodium oxide, potassium oxide, boron oxide, vanadium oxide, zinc oxide, tellurium oxide, aluminum oxide, silicon dioxide, lead oxide, tin oxide, phosphorus oxide, ruthenium oxide, rhodium oxide, iron oxide, copper oxide, manganese dioxide, molybdenum oxide, niobium oxide, titanium oxide, tungsten oxide, bismuth oxide, zirconium oxide, lithium oxide, antimony oxide, lead borate glass, tin phosphate glass, vanadate glass, and borosilicate glass. The glass frit preferably contains at least one or more kinds of transition metals to absorb infrared light.

After the frit paste 102 is provided, drying treatment may be performed to remove the organic solvent in the fit paste 102. The drying treatment is performed to dry the frit paste 102 at a temperature lower than the upper temperature limit of a material provided over the substrate 101. For example, the drying treatment may be performed at a temperature of 100° C. or higher and 200° C. or lower for 10 minutes or longer and 30 minutes or shorter.

Then, the frit paste 102 is irradiated with laser light, thereby forming the glass layer 104 from which the organic solvent and the binder are removed (FIG. 1B).

By the laser light irradiation, the glass fits contained in the fit paste 102 may be completely melted and firmly attached one another to be one, or may be partly welded. Depending on the laser light irradiation conditions, the organic solvent and the binder are not completely removed and remain in the glass layer 104 in some cases.

As the laser light, for example, laser light with a wavelength in a visible light region, an infrared region, or an ultraviolet region can be used.

Examples of the laser which emits light with a wavelength in the visible light region or the infrared region include a gas laser such as an Ar laser, a Kr laser, or a CO₂ laser; and a solid-state laser such as a YAG laser, a YVO₄ laser, a YLF laser, a YAlO₃ laser, a GdVO₄ laser, a KGW laser, a KYW laser, an alexandrite laser, a Ti:sapphire laser, or a Y₂O₃ laser. Note that in the solid-state laser, the fundamental wave or the second harmonic is preferably used. In addition, a semiconductor laser such as GaN, GaAs, GaAlAs, or InGaAsP can be used. The semiconductor laser has advantages of stable oscillation output, low maintenance frequency, and low operational costs.

Examples of the laser which emits light with a wavelength in the ultraviolet region include an excimer laser such as a XeCl laser or a KrF laser; and a solid-state laser such as a YAG laser, a YVO₄ laser, a YLF laser, a YAlO₃ laser, a GdVO₄ laser, a KGW laser, a KYW laser, an alexandrite laser, a Ti:sapphire laser, or a Y₂O₃ laser. Note that in the solid-state laser, the third harmonic or the fourth harmonic is preferably used.

The laser light irradiation start portion 111 is shown in FIG. 1A. Here, laser light irradiation is started from a position which does not overlap with the frit paste 102.

Note that the laser light irradiation start portion 111 may overlap with the substrate 101 or the frit paste 102. However, in the case where an object to be sealed is provided over the substrate 101, there is a possibility that the object is thermally damaged and degraded by the laser light irradiation. For this reason, it is preferable that neither the laser light irradiation start portion 111 nor the track of the laser light irradiation portion overlap with the object provided over the substrate 101.

In this embodiment, to prevent the track of the laser light irradiation portion from overlapping with the laser light irradiation start portion 111, laser light irradiation is performed along the frit paste 102 (see the track of solid line arrows in FIG. 1A, and the corresponding track of dotted line arrows in FIG. 1B). Then, as shown by solid line arrows in FIG. 1B, the frit paste 102 is irradiated with laser light to overlap with the track of the laser light irradiation portion, and the laser light irradiation is finished. The laser light irradiation terminating portion 112 is shown in FIG. 1B.

FIGS. 1C and 1D are enlarged views of the region 106a and a region 106b in FIG. 1B, respectively. The region 106b includes an intersection portion of the track of the laser light irradiation portion. The intersection portion includes an intersection.

In the region 106a, the continuous glass layer 104 is formed along a region where the frit paste 102 is provided as in FIG. 1C.

In the region 106b, a portion where the glass layer 104 is not formed (also referred to as glass layer disconnected portion or glass layer non-forming portion) exists in the region of the frit paste 102, and the glass layer 104 is not continuous as shown in FIG. 1D. However, the area of the glass layer non-forming portion formed by applying one embodiment of the present invention can be smaller than that formed by applying the method for forming the glass layer (the above comparative example). Thus, when a sealed structure is manufactured by bonding a pair of substrates with the glass layer 104, poor hermeticity of the sealed structure can be avoided.

Furthermore, glass fits can be prevented from aggregating at an edge of the glass layer 104 by applying one embodiment of the present invention as compared with the case of applying the method for forming the glass layer (the above comparative example). Thus, unevenness of the thickness of the glass layer 104 can be reduced, and when a pair of substrates is superposed with the glass layer 104 positioned therebetween, the glass layer 104 can come into uniform contact with the pair of substrates. The pair of substrates is bonded using the glass layer 104 melted by laser light irradiation, whereby a sealed structure having high hermeticity can be obtained.

As described above, in one embodiment of the present invention, laser light irradiation is performed in such a manner that the track of the laser light irradiation portion does not overlap with the laser light irradiation start portion. Thus, the area of the glass layer disconnected portion can be small. Moreover, a difference in thickness between an edge of the glass layer and the other region of the glass layer can be small.

FIG. 3A is an enlarged view of an intersection portion of the track of the laser light irradiation portion over the frit paste 102.

In one embodiment of the present invention, laser light irradiation is performed so that the track of the laser light irradiation portion forms an angle in the intersection portion. As shown in FIG. 3A, laser light irradiation is started from the irradiation start portion 111 and performed on the frit paste 102 to form a track of the arrow S1, the arrow S2, and the arrow S3. That is, the angle θ between the arrow S1 and the arrow S3 is not 0° in one embodiment of the present invention.

In the case where the angle between the arrow S1 and the arrow S2 (180°-θ) is small when the laser light irradiation portion moves from the arrow S1 to the arrow S2, the frit paste 102 continues to be locally irradiated with laser light. In this case, a crack may be caused in the formed glass layer 104.

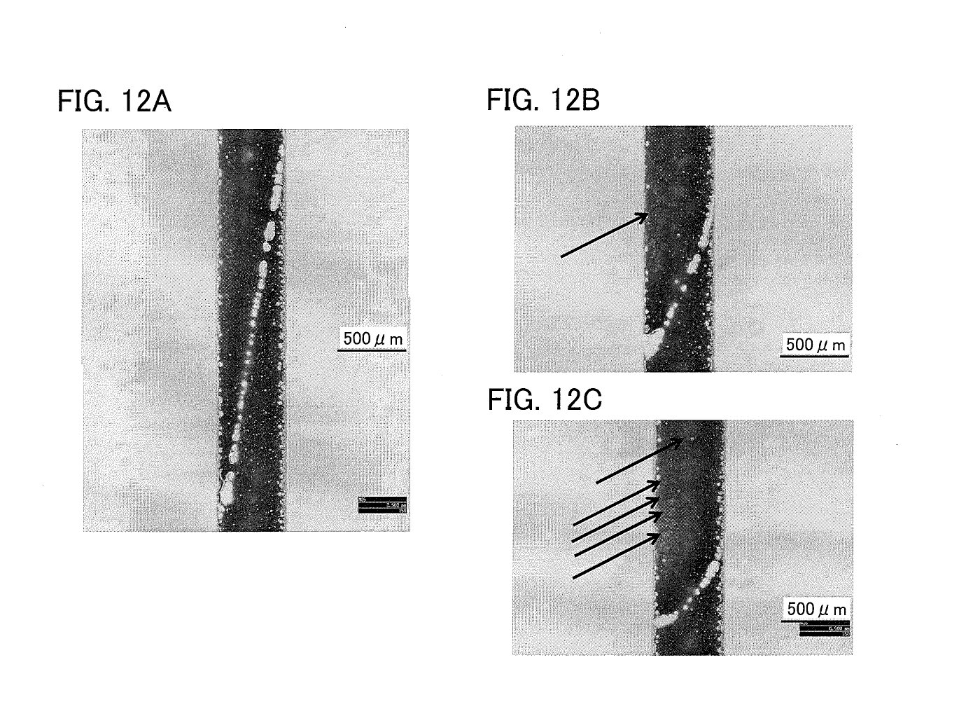

To form glass layers, the frit paste provided over the substrate is irradiated with laser light such that the track of the laser light irradiation portion forms the angle θ in the intersection portion, and the results of the formed glass layers are described here using FIGS. 12A to 12C. FIGS. 12A to 12C are digital micrographs of glass layers with θ=10°, θ=30°, and θ=80°, respectively.

In this case, the frit paste was subjected to drying treatment at 200° C. for 20 minutes, and then irradiated with laser light. The laser light irradiation was performed under the following conditions: a semiconductor laser with a wavelength of 820 nm was used, the spot size φ was 0.8 mm, the output power was 6.5 W, and the scanning speed was 30 mm/sec. Note that the used laser light was continuous wave (CW) laser light.

FIGS. 12B and 12C show that the number of cracks in the glass layer with θ=30° is smaller than that in the glass layer with θ=80° (the positions of cracks are indicated by arrows). Besides, as shown in FIG. 12A, no crack is observed in the glass layer with θ=10°.

Therefore, in the case where the track of the laser light irradiation portion forms the angle θ, the angle θ is preferably as small as possible because occurrence of cracks in the glass layer 104 can be reduced. Specifically, the angle θ is preferably larger than 0° and smaller than 80°, more preferably larger than 0° and smaller than or equal to 60°, even more preferably larger than 0° and smaller than or equal to 40°, still more preferably larger than 0° and smaller than or equal to 20°.

As the angle θ is larger, the area S of the glass layer non-forming portion can be small, which is described later in Example 1. The area S of the glass layer non-forming portion is preferably as small as possible, because when a pair of substrates is bonded using the glass layer 104 to form a sealed structure, the possibility of poor hermeticity of the sealed structure can be reduced. Specifically, the angle θ is preferably larger than or equal to 30° and smaller than or equal to 90°, more preferably larger than or equal to 50° and smaller than or equal to 90°, even more preferably larger than or equal to 70° and smaller than or equal to 90°, still more preferably larger than or equal to 80° and smaller than or equal to 90°.

When the track of the laser light irradiation portion forms the angle θ, the angle θ is preferably greater than 0° and less than or equal to 90°, more preferably greater than or equal to 10° and less than or equal to 80°, even more preferably greater than or equal to 20° and less than or equal to 70°, still more preferably greater than or equal to 30° and less than or equal to 60°, and particularly preferably greater than or equal to 40° and less than or equal to 50°. When the angle θ is larger than or equal to 30° and less than 80°, occurrence of cracks in the glass layer 104 can be reduced, and a sealed structure having high hermeticity can be formed using the glass layer 104 because the area S of the glass layer non-forming portion can be small.

Note that as shown in FIG. 3B, the laser light irradiation portion may be moved from the laser light irradiation start portion 111 to a corner portion (curve portion) of the frame-like frit paste 102. At this time, an angle between the arrow S1 and the tangent to the track at the intersection between the arrow Si and the arrow S3 corresponds to the angle θ.

In manufacturing or using a device including a sealed structure, force is more likely to be applied to a corner portion of the device, so that the pair of bonded substrates tends to be detached at the corner portion. For this reason, it is preferable that especially the corner portion of the sealed structure have high hermeticity.

The intersection portion is preferably a side portion (straight portion). When the intersection portion is in a region other than the corner portion (curve portion), occurrence of cracks in the corner portion of the glass layer 104 can be reduced. Moreover, occurrence of the glass layer non-forming portion in the corner portion of the glass layer 104 can be reduced.

In the case where the fit paste 102 has a projection portion 108 as illustrated in FIGS. 3C and 3D, laser light irradiation may be started from the laser light irradiation start portion 111 overlapping with the projection portion 108. The laser light irradiation is performed along the frit paste 102 as shown by solid line arrows in FIG. 3C (corresponding to a track of dotted line arrows in FIG. 3D). Then, laser light irradiation is performed to overlap with the track of the laser light irradiation portion as shown by the solid line arrows in FIG. 3D, and the laser light irradiation is finished in the irradiation terminating portion 112.

### <Sealed Structure Manufactured Using One Embodiment of the Present Invention>

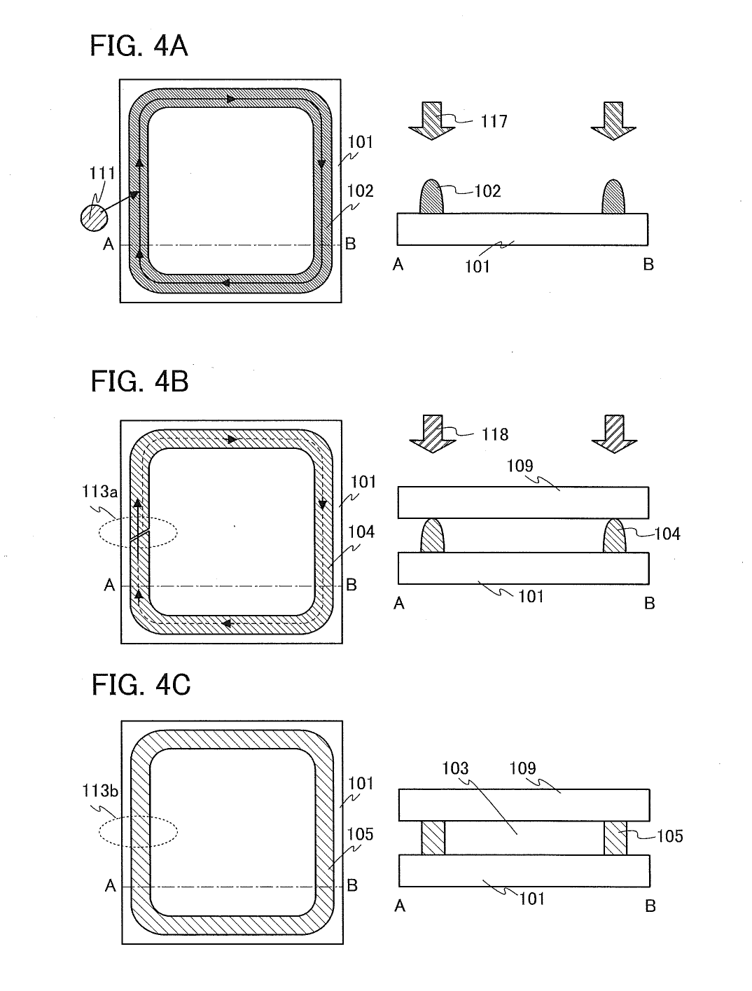

Next, a sealed structure using one embodiment of the present invention and a method for manufacturing the sealed structure will be described with reference to FIGS. 4A to 4C. Each of FIGS. 4A to 4C illustrates a plan view and a cross-sectional view taken along the alternate long and short dashed line A-B. A substrate 109 is omitted in the plan views of FIGS. 4B and 4C.

First, FIG. 4C illustrates a sealed structure manufactured by application of one embodiment of the present invention. In the sealed structure in FIG. 4C, the substrate 101 is bonded to the substrate 109 with the sealant 105. An object may be put in the space 103 formed by the substrate 101, the substrate 109, and the sealant 105.

For the substrate 101 and the substrate 109, a material is used which has heat resistance high enough to resist the process for manufacturing the sealed structure and the object sealed in the sealed structure. The substrate 101 and the substrate 109 are not particularly limited in thickness and size as long as they can be used in a manufacturing apparatus. For example, a substrate using an inorganic material, such as a glass substrate, a ceramic substrate, or a metal substrate; a substrate using a composite material of an organic material and an inorganic material, such as a lamination of a resin substrate and an inorganic material, fiber-reinforced plastics (FRP), or a prepreg, can be used. The substrate 101 and the substrate 109 may have flexibility with which the sealed object is not broken. For example, glass or a metal foil as thin as 50 μm to 500 μm can be used. Note that at least one of the substrate 101 and the substrate 109 is used with a material that transmits laser light.

The space 103 formed by the substrate 101, the substrate 109, and the sealant 105 may be filled with an inert gas such as a rare gas or a nitrogen gas or a solid such as a resin, or may be in a reduced pressure atmosphere. A dry agent may be provided in the space 103.

The object sealed in the sealed structure of one embodiment of the present invention is not particularly limited. Examples of the object include a semiconductor element such as a transistor; a light-emitting element; a liquid crystal element; an element included in a plasma display; and a color filter. The category of the light-emitting element includes an element whose luminance is controlled by current or voltage, and specifically includes an inorganic EL element and an organic EL element. Furthermore, a display medium whose contrast is changed by an electric effect, such as an electronic ink display (electronic paper), can be used.

The sealant 105 can be formed using a glass frit or a glass ribbon. The glass fit or the glass ribbon contains a glass material.

### <Method for Manufacturing Sealed Structure of One Embodiment of the Present Invention>

First, the frit paste 102 including a glass fit, an organic solvent, and a binder is provided over the substrate 101 (FIG. 4A).

Next, the frit paste 102 is irradiated with first laser light 117, thereby forming the glass layer 104 from which the organic solvent and the binder are removed (FIG. 4B). For the formation of the glass layer 104, the method for forming a glass layer of one embodiment of the present invention may be used.

The irradiation with the first laser light 117 is started from the irradiation start portion 111. A portion irradiated with the first laser light 117 does not overlap with the irradiation start portion 111, and moves relatively over the frit paste 102 (see the track of the solid line arrows in FIG. 4A and the track of the dotted line arrows in FIG. 4B).

Then, as shown by solid line arrows in FIG. 4B, the fit paste 102 is irradiated with the first laser light 117 to overlap with the track of the portion irradiated with the first laser light 117, and irradiation with the first laser light 117 is finished.

The top surface of the glass layer 104 is preferably flat to increase the adhesion to the counter substrate. Treatment for obtaining uniform thickness and flatness may be performed; for example, a flat plate or the like may be pressed against the glass layer 104; or the top surface of the glass layer 104 may be flattened with the use of a spatula. Such treatment can be performed before or after the formation of the glass layer 104.

Next, the substrate 109 is provided to face the substrate 101 with the glass layer 104 positioned therebetween. Then, the glass layer 104 is locally heated by irradiation with a second laser light 118. Thus, the glass frit is melted to bond the substrate 101 and the substrate 109 (FIG. 4C).

The irradiation with the second laser light 118 is preferably performed along the region where the glass layer 104 is provided. The irradiation with the second laser light 118 may be performed on the substrate 101 side or the substrate 109 side. In this embodiment, the irradiation with the second laser light 118 is performed on the substrate 109 side, light with a wavelength which passes through the substrate 109 is emitted as the second laser light 118. For example, light with a wavelength in the visible light region or the infrared region is emitted. Alternatively, with the use of light having high energy which does not pass through the substrate (e.g., wavelength in an ultraviolet region), the glass layer can be directly irradiated with the laser light and heated.

In the irradiation with the second laser light 118 for heating the glass frit, a pressure is preferably applied so that the glass layer 104 and the substrate 109 can be in contact with each other without fail. For example, the pressure may be applied to the glass layer 104 with the substrate 101 and the substrate 109 held with a clamp outside the region irradiated with the second laser light 118, or the pressure may be applied to one or both of the surfaces of the substrate 101 and the substrate 109.

The space 103 is preferably brought into an inert gas atmosphere or a reduced pressure atmosphere after the irradiation with the second laser light 118. For example, before the irradiation with the second laser light 118, a resin such as an ultraviolet curable resin or a thermosetting resin is provided in advance outside or inside a region where the frit paste 102 is applied; the substrate 101 and the substrate 109 are temporarily bonded to each other in an inert gas atmosphere or a reduced pressure atmosphere and then irradiated with the second laser light 118 in an air atmosphere or an inert gas atmosphere. Since the glass layer 104 is formed in a frame-like shape, the space 103 can be kept in the inert gas atmosphere or the reduce pressure atmosphere, and laser light irradiation can be performed in atmospheric pressure; thus, the structure of a device can be simplified. The space 103 is brought into a reduced pressure atmosphere in advance, whereby the glass layer 104 and the substrate 109 can be in contact with each other without fail even without using a mechanism such as a clamp for pressing the glass layer 104 and the substrate 109 at the time of laser light irradiation.

In a region 113a in FIG. 4B, a portion where the glass layer 104 is not formed exists in the region of the frit paste 102, that is, the glass layer 104 is not connected. However, the area of the glass layer non-forming portion is small. In a region 113b in FIG. 4C, the glass layer non-forming portion is filled with the glass layer melted by irradiation with the second laser light 118; thus, the sealant 105 has no disconnected portion. As described above, by application of one embodiment of the present invention, a sealed structure with high hermeticity can be manufactured.

To fill the glass layer non-forming portion, for example, there is a method in which a glass layer is formed to have a thicker portion, and the thicker portion is irradiated with laser light. However, by the method for forming a glass layer of one embodiment of the present invention, the area of the glass layer non-forming portion can be sufficiently small and the glass layer does not necessarily have a thicker portion. As a result, laser light irradiation time can be reduced and the laser light scanning speed can be increased in the formation of the glass layer or the sealed structure.

The glass layer 104 is observed with an optical microscope before and after the step of bonding the pair of substrates (the substrate 101 and the substrate 109) with the glass layer 104, and the results are described here.

First, under the reduced pressure atmosphere, the pair of substrates is provided to face each other with the glass layer 104 positioned therebetween. The pair of substrates is prebonded using an ultraviolet curable resin that is provided in one of the substrates in advance to surround the outer edge of the glass layer 104. Then, laser light irradiation is performed on the glass layer 104 through the substrate 101, whereby the pair of substrates is bonded.

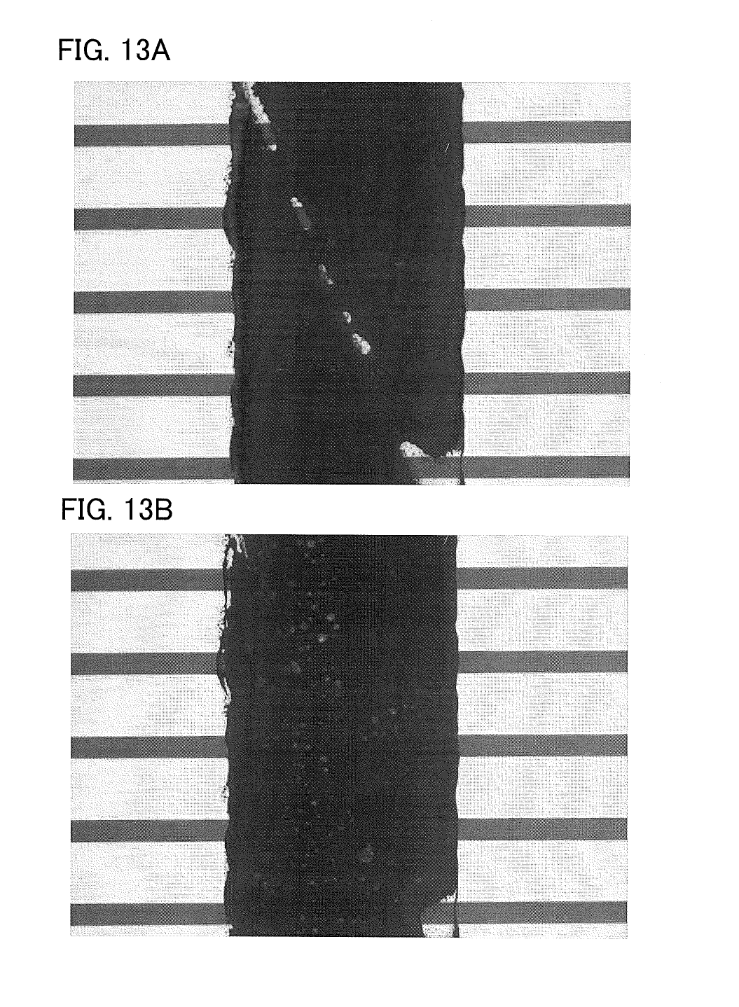

FIG. 13A shows the results before the bonding, and FIG. 13B shows the results after the bonding. FIG. 13A corresponds to the result of optical microscope observation of the glass layer 104 in the region 113a in FIG. 4B, and FIG. 13B corresponds to the result of optical microscope observation of the glass layer 104 in the region 113b in FIG. 4C.

Here, glass substrates are used as the substrate 101 and the substrate 109. By applying a pressure of 1 kN at a degree of vacuum of 1 Pa, the glass layer 104 is tightly attached to the substrate 109. The laser light irradiation was performed under the following conditions: a semiconductor laser with a wavelength of 820 nm was used, the spot size φ was 0.8 mm, the output power was 7 W, and the scanning speed was 10 mm/sec. Note that the used laser light was continuous wave laser light.

Just after the glass layer 104 is formed over the substrate 101, the glass layer non-forming portion exists as shown in FIG. 13A. On the other hand, after the substrate 101 and the substrate 109 are bonded, the glass layer non-forming portion is filled with the melted glass layer as shown in FIG. 13B. These results show that with the use of a glass layer formed by applying one embodiment of the present invention, a sealed structure with high hermeticity can be manufactured.

In particular, irradiation with the second laser light 118 is performed more than once in the vicinity of the glass layer non-forming portion (or an edge of the glass layer 104), in which case the edge of the glass layer 104 is melted more surely to fill the glass layer non-forming portion. For example, an intersection portion of the track of the irradiation portion with the second laser light 118 is preferably in the vicinity of the glass layer non-forming portion. The irradiation with the second laser light 118 may be performed more than once on the intersection portion of the track of the irradiation portion with the first laser light 117.

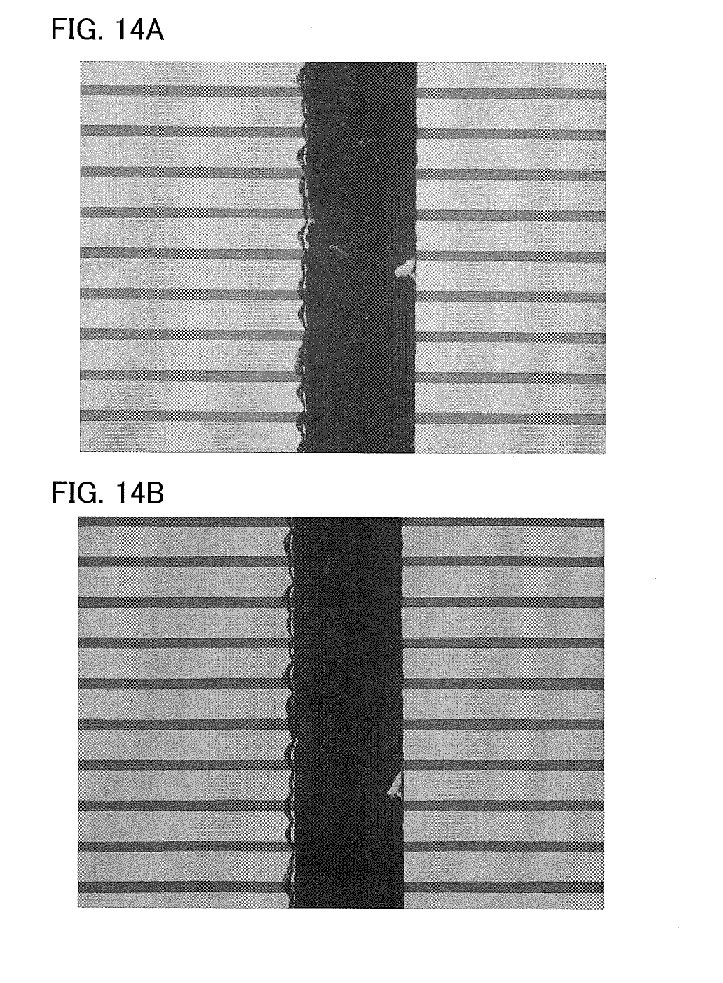

FIGS. 14A and 14B show the results of optical microscope observation of the glass layer 104 after irradiation with the second laser light 118 in the vicinity of the glass layer non-forming portion. FIG. 14A shows the result after irradiation with the second laser light 118 is performed once, and FIG. 14B shows the results after irradiation with the second laser light 118 is performed twice. These results show that the glass layer non-forming portion is more effectively filled with the melted glass layer by performing irradiation with the second laser light 118 in the vicinity of the glass layer non-forming portion twice comparing with by performing once.

Furthermore, glass frits can be prevented from aggregating at an edge of the glass layer 104 by applying one embodiment of the present invention. Thus, unevenness of the thickness of the glass layer 104 can be reduced, and when a pair of substrates is superposed with the glass layer 104 positioned therebetween, the glass layer 104 can come into uniform contact with the pair of substrates. The pair of substrates is bonded using the glass layer 104 melted by irradiation with the second laser light 118, whereby a sealed structure having high hermeticity can be obtained.

As described above, in this embodiment, laser light irradiation is performed in the process for forming the glass layer such that the track of the laser light irradiation portion has an intersection portion which does not overlap with the laser light irradiation start portion. In this case, the area of the disconnected portion in the glass layer can be reduced as compared with the case where the intersection portion overlaps with the laser light irradiation start portion. The disconnected portion in the glass layer can be sufficiently filled with the glass layer melted in the step of bonding the pair of substrates. Therefore, with the use of a glass layer formed by applying one embodiment of the present invention, a sealed structure with high hermeticity can be manufactured.

This embodiment can be combined with any other embodiment as appropriate.

### Embodiment 2

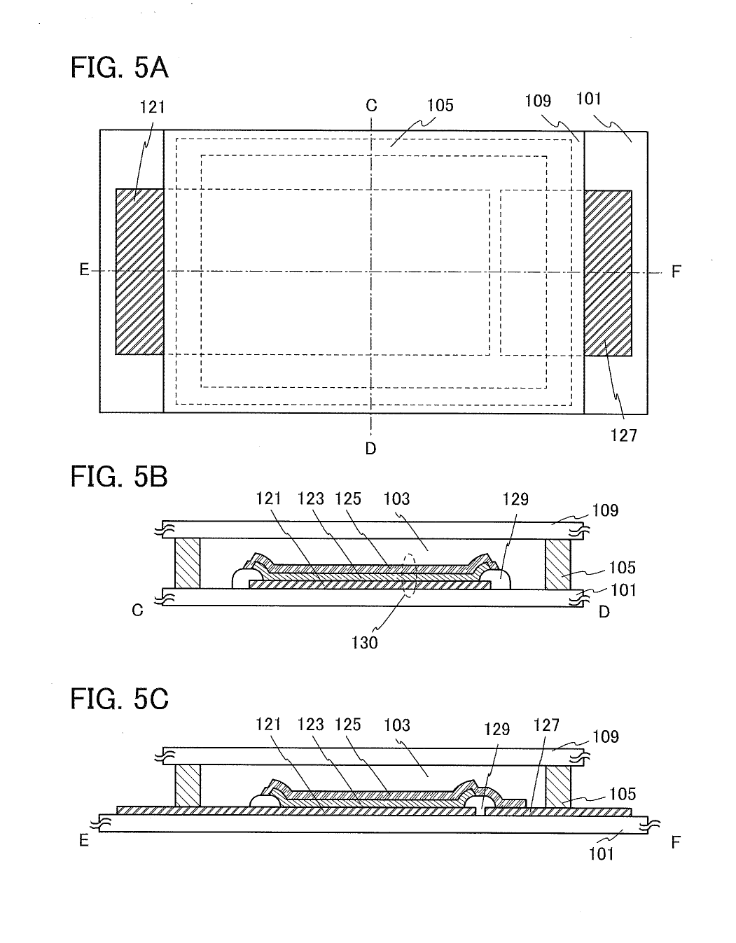

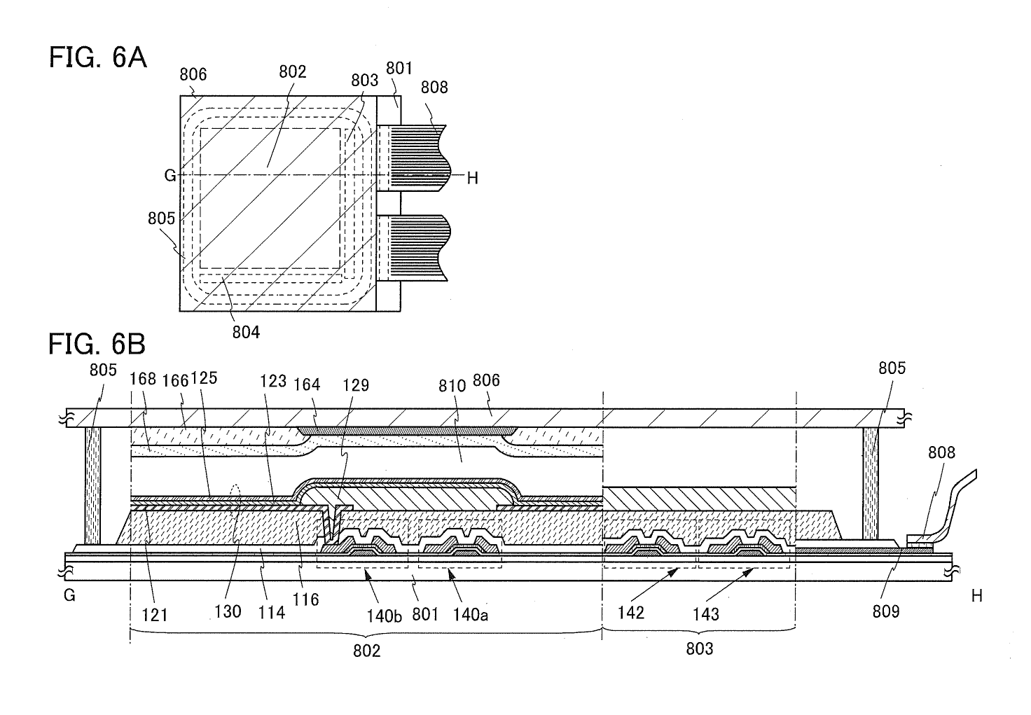

In this embodiment, description will be given on an example of the light-emitting device using the sealed structure that is manufactured by application of one embodiment of the present invention, with reference to FIGS. 5A to 5C and FIGS. 6A and 6B.

The light-emitting device of this embodiment has high reliability because a light-emitting element, which is an object to be sealed, is sealed in the sealed structure of one embodiment of the present invention. Similarly, a highly reliable semiconductor device, display device or the like can be manufactured by sealing a semiconductor element or a display element in the sealed structure of one embodiment of the present invention.

In this embodiment, a light-emitting device including an organic EL element that is a light-emitting element is described as an example.

FIG. 5A is a plan view of a light-emitting device of one embodiment of the present invention. FIG. 5B is a cross-sectional view taken along the alternate long and short dashed line C-D in FIG. 5A. FIG. 5C is a cross-sectional view taken along the alternate long and short dashed line E-F in FIG. 5A.

As illustrated in FIGS. 5A to 5C, the light-emitting device of this embodiment includes the substrate 101 and the substrate 109 the first surfaces of which face each other; the frame-like sealant 105 which seals the space 103 with the substrate 101 and the substrate 109; and a light-emitting element 130 provided on the first surface of the substrate 101.

The light-emitting element 130 includes a first electrode 121 over the substrate 101; an EL layer 123 over the first electrode 121; and a second electrode 125 over the EL layer 123. An edge of the first electrode 121 is covered with a partition wall 129.

The second electrode 125 is electrically connected to a conductive layer 127 over the substrate 101. The first electrode 121 and the conductive layer 127 overlap with part of the sealant 105. The first electrode 121 and the conductive layer 127 are electrically insulated by the partition wall 129.

The first electrode 121 and the conductive layer 127 extend beyond a region (also referred to as sealed region) sealed by the substrate 101, the substrate 109, and the sealant 105.

FIG. 6A is a plan view of a light-emitting device of one embodiment of the present invention. FIG. 6B is a cross-sectional view taken along the alternate long and short dashed line G-H in FIG. 6A.

An active matrix light-emitting device illustrated in FIGS. 6A and 6B includes, over a support substrate 801, a light-emitting portion 802, a driver circuit portion 803 (gate side driver circuit portion), a driver circuit portion 804 (source side driver circuit portion), and the sealant 805. The light-emitting portion 802 and the driver circuit portions 803 and 804 are sealed in a space 810 surrounded by the support substrate 801, a sealing substrate 806, and the sealant 805.

The light-emitting portion 802 illustrated in FIG. 6B includes a plurality of light-emitting units each including a switching transistor 140a, a current control transistor 140b, and the first electrode 121 electrically connected to a wiring (a source electrode or a drain electrode) of the current control transistor 140b.

The light-emitting element 130 has a top emission structure, including the first electrode 121, the EL layer 123, and the second electrode 125. The partition wall 129 is formed to cover an end portion of the first electrode 121.

Over the support substrate 801, a lead wiring 809 for connecting an external input terminal through which a signal (e.g., a video signal, a clock signal, a start signal, or a reset signal) or a potential from the outside is transmitted to the driver circuit portions 803 and 804 is provided. Here, an example in which a flexible printed circuit (FPC) 808 is provided as the external input terminal is described. Note that a printed wiring board (PWB) may be attached to the FPC 808. In this specification, the light-emitting device includes in its category the light-emitting device itself and the light-emitting device on which the FPC or the PWB is mounted.

The driver circuit portions 803 and 804 have a plurality of transistors. FIG. 6B illustrates an example in which the driver circuit portion 803 has a CMOS circuit which is a combination of an n-channel transistor 142 and a p-channel transistor 143. A circuit included in the driver circuit portion can be formed with various types of circuits such as a CMOS circuit, a PMOS circuit, or an NMOS circuit. The present invention is not limited to a driver-integrated type described in this embodiment in which the driver circuit is formed over the substrate over which the light-emitting portion is formed. The driver circuit can be formed over a substrate that is different from the substrate over which the light-emitting portion is formed.

To prevent increase in the number of manufacturing steps, the lead wiring 809 is preferably formed using the same material in the same step(s) as those of the electrode or the wiring in the light-emitting portion or the driver circuit portion. Described in this embodiment is an example in which the lead wiring 809 is formed using the same material in the same step(s) as those of the gate electrode of the transistor included in the light-emitting portion 802 and the driver circuit portion 803.

### <Material of Light-Emitting Device>

A material that can be used for a light-emitting device will be described. As for the substrate, the sealant, and the space, their respective materials described in the above embodiments can be used.

### [Light-Emitting Element]

A light-emitting element included in the light-emitting device includes a pair of electrodes (the first electrode 121 and the second electrode 125); and the EL layer 123 between the pair of electrodes. One of the pair of electrodes functions as an anode and the other functions as a cathode.

In the case where the light-emitting element has a top emission structure, a conductive film that transmits visible light is used for an upper electrode, and a conductive film that reflects visible light is preferably used for a lower electrode. In the case where the light-emitting element has a bottom emission structure, a conductive film that transmits visible light is used for a lower electrode, and a conductive film that reflects visible light is preferably used for an upper electrode. In the case where the light-emitting element has a dual emission structure, a conductive film that transmits visible light is used for upper and lower electrodes.

The conductive film that transmits visible light can be formed using, for example, indium oxide, indium tin oxide, indium zinc oxide, zinc oxide, or zinc oxide to which gallium is added. Alternatively, a film of a metal material such as gold, platinum, nickel, tungsten, chromium, molybdenum, iron, cobalt, copper, palladium, or titanium, or a nitride of any of these metal materials (e.g., titanium nitride) which has a small thickness to transmit light can be used as the conductive film. Further alternatively, graphene or the like can be used.

The conductive film that reflects visible light can be formed using, for example, a metal material such as aluminum, gold, platinum, silver, nickel, tungsten, chromium, molybdenum, iron, cobalt, copper, or palladium; an aluminum-containing alloy (aluminum alloy) such as an alloy of aluminum and titanium, an alloy of aluminum and nickel, or an alloy of aluminum and neodymium; or a silver-containing alloy such as an alloy of silver and copper. An alloy of silver and copper is preferable because of its high heat resistance. Further, lanthanum, neodymium, or germanium may be added to the metal material or the alloy.

The electrodes may be formed separately by a vacuum evaporation method or a sputtering method. Alternatively, when a silver paste or the like is used, a coating method or an inkjet method may be used.

When a voltage higher than the threshold voltage of the light-emitting element is applied between the first electrode 121 and the second electrode 125, holes are injected from the first electrode 121 side to the EL layer 123 and electrons are injected from the second electrode 125 side to the EL layer 123. The injected electrons and holes are recombined in the EL layer 123 and a light-emitting substance contained in the EL layer 123 emits light.

The EL layer 123 includes at least a light-emitting layer. In addition to the light-emitting layer, the EL layer 123 may further include one or more layers containing any of a substance with a high hole-injection property, a substance with a high hole-transport property, a hole-blocking material, a substance with a high electron-transport property, a substance with a high electron-injection property, a substance with a bipolar property (a substance with a high electron- and hole-transport property), and the like.

For the EL layer 123, either a low molecular compound or a high molecular compound can be used, and an inorganic compound may also be used. The above-described layers included in the EL layer 123 can be formed separately by any of the following methods: an evaporation method (including a vacuum evaporation method), a transfer method, a printing method, an inkjet method, a coating method, and the like.

### [Partition Wall]

As a material for the partition wall 129, a resin or an inorganic insulating material can be used. As the resin, for example, a polyimide resin, a polyamide resin, an acrylic resin, a siloxane resin, an epoxy resin, or a phenol resin can be used. In particular, either a negative photosensitive resin or a positive photosensitive resin is preferably used for easy formation of the partition wall 129.

The partition wall 129 is provided so as to cover an end portion of the first electrode 121. The partition wall 129 is preferably formed to have a curved surface with curvature in its upper end portion or lower end portion in order to improve the coverage with the EL layer 123 or the second electrode 125 which is formed over the partition wall 129.

There is no particular limitation to the method for forming the partition wall; a photolithography method, a sputtering method, an evaporation method, a droplet discharging method (e.g., an inkjet method), a printing method (e.g., a screen printing method or an off-set printing method), or the like may be used.

### [Transistor]

There is no particular limitation on the structure of the transistors (e.g., the transistors 140a, 140b, 142, and 143) included in the display device. For example, a forward staggered transistor or an inverted staggered transistor may be used. A top-gate transistor or a bottom-gate transistor may be used. A semiconductor material used for the transistors is not particularly limited, and for example, silicon or germanium can be used. Alternatively, an oxide semiconductor containing at least one of indium, gallium, and zinc, such as an In—Ga—Zn-based metal oxide, may be used.

There is no particular limitation on the crystallinity of a semiconductor material used for the transistors, and an amorphous semiconductor or a semiconductor having crystallinity (a microcrystalline semiconductor, a polycrystalline semiconductor, a single-crystal semiconductor, or a semiconductor partly including crystal regions) may be used. It is preferable that a semiconductor having crystallinity be used, in which case deterioration of the transistor characteristics can be suppressed.

### [Insulating Layer]

An insulating layer 114 has an effect of preventing diffusion of impurities into a semiconductor included in the transistor. As the insulating layer 114, typically, an inorganic insulating film such as a silicon oxide film, a silicon oxynitride film, or an aluminum oxide film can be used.

As an insulating layer 116, an insulating film having a planarization function is preferably selected in order to reduce surface unevenness due to the transistor. For example, an organic material such as a polyimide resin, an acrylic resin, or a benzocyclobutene resin can be used. Other than such organic materials, a low-dielectric constant material (a low-k material) or the like can also be used. Note that a plurality of layers of any of these materials may be stacked to form the insulating layer 116.

### [Color Filter, Black Matrix, and Overcoat]

The color filter 166 is provided in order to adjust the color of light transmitted through a pixel to increase the color purity. For example, in a full-color display device using white light-emitting elements, a plurality of pixels provided with color filters of different colors are used. In that case, three colors, red (R), green (G), and blue (B), may be used, or four colors, red (R), green (G), blue (B), and yellow (Y), may be used. Further, a white (W) pixel may be added to R, G, and B pixels (and a Y pixel).

A black matrix 164 is provided between the adjacent color filters 166. The black matrix 164 blocks light emitted from an adjacent pixel, thereby preventing color mixture between the adjacent pixels. In one configuration, the black matrix 164 may be provided only between adjacent pixels of different emission colors and not between pixels of the same emission color. Here, the color filter 166 is provided so that its end portions overlap with the black matrix 164, whereby light leakage can be reduced. The black matrix 164 can be formed using a material that blocks light transmitted through the pixel, for example, a metal material or a resin material including a pigment. Note that it is preferable to provide the black matrix 164 in a region other than the light-emitting portion 802, such as a driver circuit portion, because undesired leakage of guided light or the like can be prevented.

As illustrated in FIG. 6B, by providing an overcoat 168 covering the color filter 166 and the black matrix 164, an impurity such as a pigment included in the color filter 166 or the black matrix 164 can be prevented from diffusing into the light-emitting element or the like. For the overcoat 168, a light-transmitting material is used, and an inorganic insulating material or an organic insulating material can be used.

This embodiment can be combined with any other embodiment as appropriate.

### Embodiment 3

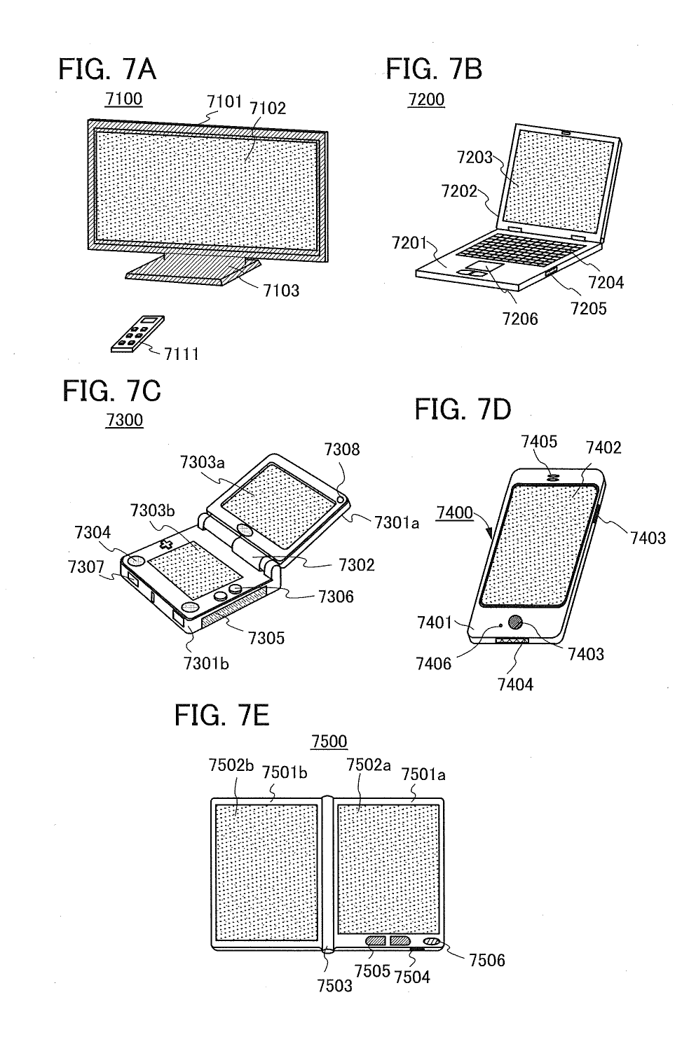

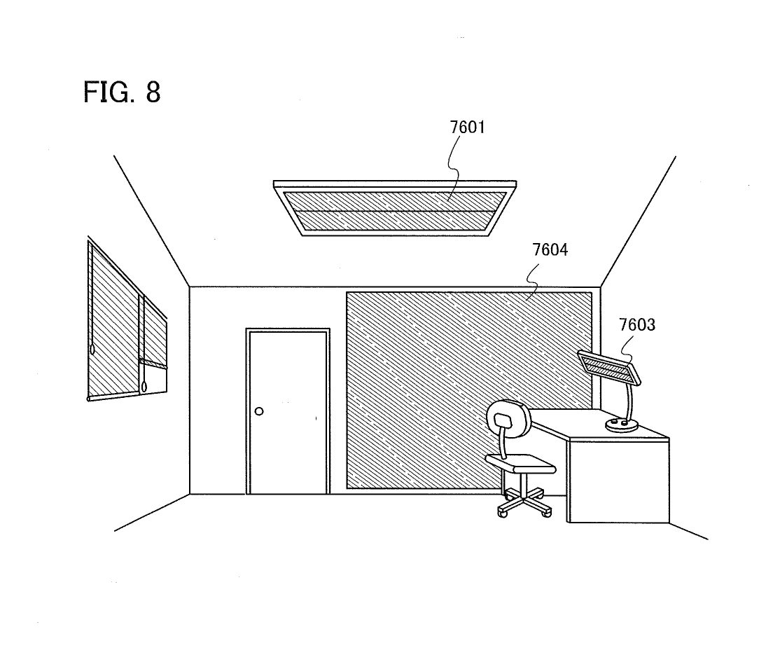

In this embodiment, examples of electronic devices and lighting devices using the sealed structure manufactured applying one embodiment of the present invention will be described with reference to FIGS. 7A to 7E and FIG. 8.

The electronic devices and lighting devices described in this embodiment have high reliability because an element corresponding to an object to be sealed (e.g., a semiconductor element, a light-emitting element, or a display element) is sealed in the sealed structure of one embodiment of the present invention.

Examples of the electronic devices to which one embodiment of the present invention is applied are television devices (also referred to as TV or television receivers), monitors for computers and the like, cameras such as digital cameras and digital video cameras, digital photo frames, cellular phones (also referred to as portable telephone devices), portable game machines, portable information terminals, audio playback devices, large game machines such as pin-ball machines, and the like. Specific examples of these electronic devices and lighting devices are illustrated in FIGS. 7A to 7E and FIG. 8.

FIG. 7A illustrates an example of a television set. In a television device 7100, a display portion 7102 is incorporated in a housing 7101. The display portion 7102 is capable of displaying images. The display device to which one embodiment of the present invention is applied can be used for the display portion 7102. In addition, here, the housing 7101 is supported by a stand 7103.

The television device 7100 can be operated with an operation switch provided in the housing 7101 or a separate remote controller 7111. With operation keys of the remote controller 7111, channels and volume can be controlled and images displayed on the display portion 7102 can be controlled. Further, the remote controller 7111 may be provided with a display portion for displaying data output from the remote controller 7111.

Note that the television device 7100 is provided with a receiver, a modem, and the like. With the receiver, a general television broadcast can be received. Furthermore, when the television device 7100 is connected to a communication network by wired or wireless connection via the modem, one-way (from a transmitter to a receiver) or two-way (between a transmitter and a receiver, between receivers, or the like) data communication can be performed.

FIG. 7B illustrates an example of a computer. A computer 7200 includes a main body 7201, a housing 7202, a display portion 7203, a keyboard 7204, an external connecting port 7205, a pointing device 7206, and the like. Note that this computer is manufactured by using the display device of one embodiment of the present invention for the display portion 7203.

FIG. 7C illustrates an example of a portable game machine A portable game machine 7300 has two housings, a housing 7301a and a housing 7301b, which are connected with a joint portion 7302 so that the portable game machine can be opened or closed. A display portion 7303a is incorporated in the housing 7301a and a display portion 7303b is incorporated in the housing 7301b. In addition, the portable game machine illustrated in FIG. 7C includes a speaker portion 7304, a recording medium insertion portion 7305, an operation key 7306, a connection terminal 7307, a sensor 7308 (a sensor having a function of measuring or sensing force, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays), an LED lamp, a microphone, and the like. The structure of the portable game machine is not limited to the above as long as the light-emitting device according to one embodiment of the present invention is used for at least either the display portion 7303a or the display portion 7303b, or both of them. The portable game machine may be provided with other accessories as appropriate. The portable game machine illustrated in FIG. 7C has a function of reading a program or data stored in a recording medium to display it on the display portion, and a function of sharing data with another portable game machine by wireless communication. Note that a function of the portable game machine illustrated in FIG. 7C is not limited to the above, and the portable game machine can have a variety of functions.

FIG. 7D illustrates an example of a cellular phone. A cellular phone 7400 is provided with a display portion 7402 incorporated in a housing 7401, operation buttons 7403, an external connection port 7404, a speaker 7405, a microphone 7406, and the like. Note that the mobile phone 7400 is manufactured by using the display device of one embodiment of the present invention for the display portion 7402.

When the display portion 7402 of the mobile phone 7400 illustrated in FIG. 7D is touched with a finger or the like, data can be input into the mobile phone 7400. Further, operations such as making a call and creating e-mail can be performed by touch on the display portion 7402 with a finger or the like.

There are mainly three screen modes of the display portion 7402. The first mode is a display mode mainly for displaying images. The second mode is an input mode mainly for inputting data such as text. The third mode is a display-and-input mode in which two modes of the display mode and the input mode are combined.

For example, in the case of making a call or composing an e-mail, a text input mode mainly for inputting text is selected for the display portion 7402 so that text displayed on a screen can be inputted.

When a detection device including a sensor for detecting inclination, such as a gyroscope sensor or an acceleration sensor, is provided inside the mobile phone 7400, display on the screen of the display portion 7402 can be automatically changed by determining the orientation of the mobile phone 7400 (whether the mobile phone is placed horizontally or vertically for a landscape mode or a portrait mode).

The screen modes are switched by touching the display portion 7402 or operating the operation buttons 7403 of the housing 7401. Alternatively, the screen modes can be switched depending on kinds of images displayed on the display portion 7402. For example, when a signal of an image displayed on the display portion is a signal of moving image data, the screen mode is switched to the display mode. When the signal is a signal of text data, the screen mode is switched to the input mode.

Moreover, in the input mode, when input by touching the display portion 7402 is not performed within a specified period while a signal detected by an optical sensor in the display portion 7402 is detected, the screen mode may be controlled so as to be switched from the input mode to the display mode.

The display portion 7402 may function as an image sensor. For example, an image of a palm print, a fingerprint, or the like is taken by touch on the display portion 7402 with the palm or the finger, whereby personal authentication can be performed. Further, by providing a backlight or a sensing light source which emits a near-infrared light in the display portion, an image of a finger vein, a palm vein, or the like can be taken.

FIG. 7E illustrates an example of a foldable tablet terminal (in an open state). A tablet terminal 7500 includes a housing 7501a, a housing 7501b, a display portion 7502a, and a display portion 7502b. The housing 7501a and the housing 7501b are connected by a hinge 7503 and can be opened and closed along the hinge 7503. The housing 7501a includes a power switch 7504, operation keys 7505, a speaker 7506, and the like. Note that the tablet terminal 7500 is manufactured using the display device according to one embodiment of the present invention for either the display portion 7502a or the display portion 7502b, or both of them.

Part of the display portion 7502a or the display portion 7502b, in which data can be input by touching displayed operation keys can be used as a touch panel region. For example, the entire area of the display portion 7502a can display keyboard buttons and serve as a touch panel while the display portion 7502b can be used as a display screen.

An indoor lighting device 7601, a desk lamp 7603, and a planar lighting device 7604 illustrated in FIG. 8 are each an example of a lighting device which includes the light-emitting device of one embodiment of the present invention. Since the light-emitting device of an embodiment of the present invention can also have a larger area, the light-emitting device of an embodiment of the present invention can be used as a lighting system having a large area. Further, since the light-emitting device is thin, the light-emitting device can be mounted on a wall.

This embodiment can be combined with any other embodiment as appropriate.

### EXAMPLE 1

In this example, description will be made on the results of formation of a glass layer to which one embodiment of the present invention is applied.

In this example, 10 samples (Samples 1 to 9 and Comparative sample) were made. The method for forming a glass layer described in Embodiment 1 was applied to Samples 1 to 9, and the method for forming a glass layer (a comparative example) described in Embodiment 1 was applied to Comparative sample.

First, the frit paste 102 was provided to form a frame-like shape over the substrate 101 by a screen printing method (FIG. 4A). A glass substrate was used as the substrate 101, and a glass paste containing bismuth oxide or the like was used as the frit paste 102.

Then, drying treatment was performed in a clean oven at 200° C. for 20 minutes.

Next, the frit paste 102 was irradiated with the first laser light 117 to form the glass layer 104 (FIG. 4B). The laser light irradiation was performed under the following conditions: a semiconductor laser with a wavelength of 820 nm was used, the spot size φ was 0.8 mm, the output power was 3.5 W, and the scanning speed was 10 mm/sec. Note that the used laser light was continuous wave laser light.

In Samples 1 to 9, the irradiation start portion 111 of the first laser light 117 was a region over the substrate 101 which does not overlap with the frit paste 102. The irradiation with the first laser light 117 was performed along the frit paste 102 not to overlap with the irradiation start portion 111. Then, the frit paste 102 was irradiated with the first laser light 117 such that the track of the irradiated portion with the first laser light 117 overlaps with the intersection portion, the irradiation with the first laser light 117 was finished. The track of the irradiated portion with the first laser light 117 on the frit paste 102 forms an angle, and the angles in Samples 1 to 9 (the angle θ in FIG. 3A) were 10°, 20°, 30°, 40°, 50°, 60°, 70°, 80°, and 90°, respectively.

In Comparative sample, the irradiation with the first laser light 117 was started over the frit paste 102 and performed along the frit paste 102. Specifically, a laser was turned on in a state where a shutter was provided between the laser and the frit paste 102, and then the shutter was removed therefrom and the frit paste 102 was irradiated with the first laser light 117. The laser light irradiation was performed such that the track of a portion irradiated with the first laser light 117 overlaps with the irradiation start portion of the first laser light 117 (θ=0°).

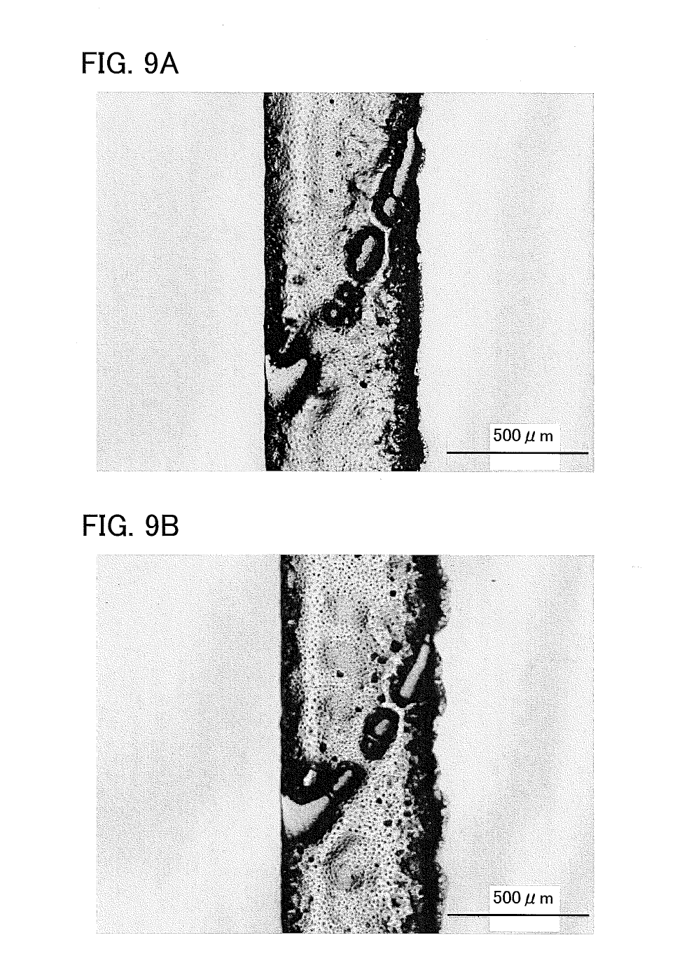

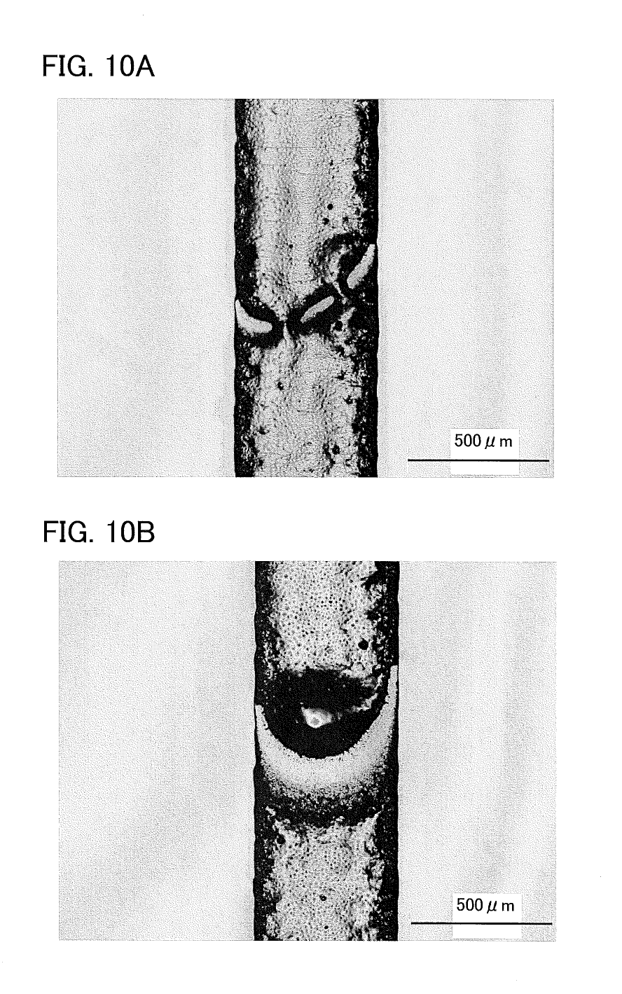

FIGS. 9A and 9B and FIGS. 10A and 10B show the results of optical microscope observation of the glass layer 104 formed over the substrate 101. The region of the results corresponds to the region 113a in FIG. 4B. FIG. 9A, FIG. 9B, and FIG. 10A show the results of Samples made under the conditions of θ=30°, θ=50°, and θ=80°, respectively, and FIG. 10B shows the result of Comparative sample (θ=0°).

As shown in FIGS. 9A and 9B and FIGS. 10A and 10B, a glass layer non-forming portion exists in each of Samples and Comparative sample, and the glass layer 104 is not connected.

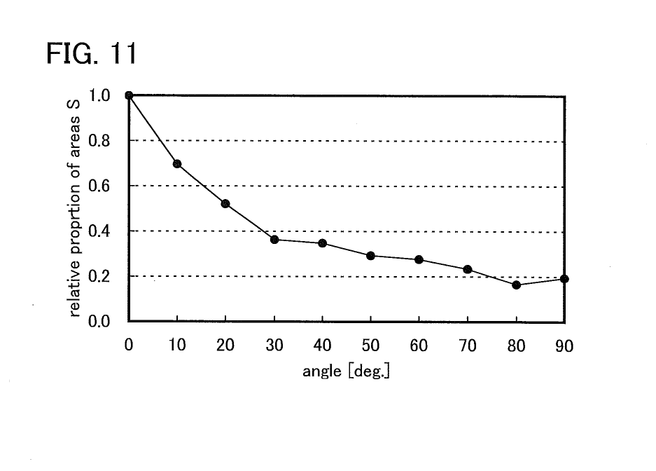

FIG. 11 shows the area S of the glass layer non-forming portion in each of Samples. In FIG. 11, the areas S of Samples 1 to 9 are expressed as a relative proportion where the area S of Comparative sample is defined as 1.

As shown in FIG. 11, the area S of each of Samples 1 to 9 to which one embodiment of the present invention is applied is smaller than the area S of Comparative sample. In particular, the area S of each of Samples having an angle θ of 30° or larger and 90° or smaller is less than or equal to half of the area S of Comparative sample; the area S of each of Samples having an angle θ of 80° or larger and 90° or smaller is less than or equal to a fifth of the area S of Comparative sample.

When the area of the glass layer non-forming portion is large, the glass layer cannot sufficiently be welded to the pair of substrates in a process for bonding the pair of substrates performed later, which leads to poor hermeticity of a manufactured sealed structure. However, by applying one embodiment of the present invention, the area of the glass layer non-forming portion can be small; thus, a sealed structure manufactured through the bonding process can have high hermeticity.

This application is based on Japanese Patent Application serial no. 2013-019095 filed with Japan Patent Office on Feb. 4, 2013, the entire contents of which are hereby incorporated by reference.

What is claimed is:

1. A method for forming a glass layer, comprising the steps of:
providing a frit paste comprising a glass frit and a binder over a substrate; and
irradiating the frit paste with a laser light by relatively moving an irradiation portion of the laser light over the frit paste,
wherein the irradiation portion of the laser light and an irradiation start portion of the laser light do not overlap each other, and
wherein a track of the irradiation portion includes an intersection in an intersection portion.

2. The method for forming a glass layer according to claim 1, wherein the track of the irradiation portion forms an angle in the intersection portion.

3. The method for forming a glass layer according to claim 2, wherein the angle is greater than 0° and less than or equal to 90°.

4. The method for forming a glass layer according to claim 1, wherein the frit paste is provided in a frame-like shape.

5. The method for forming a glass layer according to claim 1, wherein the irradiation start portion and the frit paste do not overlap each other.

6. A method for forming a glass layer, comprising the steps of:
providing a frit paste comprising a glass frit and a binder over a substrate; and
irradiating the frit paste with a laser light by relatively moving an irradiation portion of the laser light over the frit paste,
wherein the irradiation portion of the laser light and an irradiation start portion of the laser light do not overlap each other, and
wherein a first part of a track of the irradiation portion and a second part of the track of the irradiation portion cross each other.

7. The method for forming a glass layer according to claim 6,
wherein the first part of the track of the irradiation portion and the second part of the track of the irradiation portion form an angle.

8. The method for forming a glass layer according to claim 7, wherein the angle is greater than 0° and less than or equal to 90°.

9. The method for forming a glass layer according to claim 6, wherein the frit paste is provided in a frame-like shape.

10. The method for forming a glass layer according to claim 6, wherein the irradiation start portion and the frit paste do not overlap each other.

11. A method for manufacturing a sealed structure, comprising the steps of:
providing a frit paste comprising a glass fit and a binder over a first substrate;
irradiating the frit paste with a first laser light to form a glass layer by relatively moving an irradiation portion of the first laser light over the frit paste; and
bonding the first substrate and a second substrate to face each other with the glass layer positioned therebetween by irradiating the glass layer with a second laser light to melt the glass layer,
wherein the irradiation portion of the first laser light and an irradiation start portion of the first laser light do not overlap each other, and
wherein a track of the irradiation portion includes an intersection in an intersection portion.

12. The method for manufacturing a sealed structure according to claim 11, wherein the track of the irradiation portion forms an angle in the intersection portion.

13. The method for manufacturing a sealed structure according to claim 12, wherein the angle is greater than 0° and less than or equal to 90°.

14. The method for manufacturing a sealed structure according to claim 11, wherein the frit paste is provided in a frame-like shape.

15. The method for manufacturing a sealed structure according to claim 11, wherein in the intersection portion, the glass layer is irradiated with the second laser light more than once.

16. The method for manufacturing a sealed structure according to claim 11, wherein the irradiation start portion and the frit paste do not overlap each other.

17. A method for manufacturing a sealed structure, comprising the steps of:
providing a fit paste comprising a glass frit and a binder over a first substrate;
irradiating the frit paste with a first laser light to form a glass layer by relatively moving an irradiation portion of the first laser light over the frit paste; and
bonding the first substrate and a second substrate to face each other with the glass layer positioned therebetween by irradiating the glass layer with a second laser light to melt the glass layer,
wherein the irradiation portion of the first laser light and an irradiation start portion of the first laser light do not overlap each other, and
wherein a first part of a track of the irradiation portion and a second part of the track of the irradiation portion cross each other in an intersection portion.

18. The method for manufacturing a sealed structure according to claim 17, wherein the first part of the track of the irradiation portion and the second part of the track of the irradiation portion form an angle.

19. The method for manufacturing a sealed structure according to claim 18, wherein the angle is greater than 0° and less than or equal to 90°.

20. The method for manufacturing a sealed structure according to claim 17, wherein the fit paste is provided in a frame-like shape.

21. The method for manufacturing a sealed structure according to claim 17, wherein in the intersection portion, the glass layer is irradiated with the second laser light more than once.

22. The method for manufacturing a sealed structure according to claim 17, wherein the irradiation start portion and the frit paste do not overlap each other.
